(19) United States
(12) Patent Application Publication
(10) Pub. No.: US 2007/0027772 A1
(43) Pub. Date: Feb. 1, 2007

(54) Method and system for web page advertising, and method of running a web page advertising agency

(75) Inventor: Peilin Chou, Taipei (TW)

Correspondence Address: PILLSBURY WINTHROP SHAW PITTMAN, LLP, P.O. BOX 10500, MCLEAN, VA, 22102, US

(73) Assignee: BRIDGE WELL INCORPORATED, Taipei (TW)

(21) Appl. No.: 11/520,652

(22) Filed: Sep. 14, 2006

Related U.S. Application Data
(63) Continuation-in-part of application No. 11/190,979, filed on Jul. 28, 2005.

(30) Foreign Application Priority Data
Oct. 19, 2005 (TW) 094136628

(51) Int. Cl. G06Q 30/00

(52) U.S. Cl. 705/14

(57) ABSTRACT

In a web page advertising method with a learning mechanism, a plurality of advertisement files are transformed to vector equations in advance. Content of a web page file that is being displayed is analyzed and transformed to a vector equation in real time. An advertisement search conditional set is determined according to the analyzed web page file. The advertisement files are subjected to a similarity analysis using vector computations so as to select at least one advertisement file that has a high correlation to the overall concept of the content of the web page. Adjustment and training with the advertisement file are conducted through analyzing actions of a user, thereby increasing considerably the click rate of the advertisement file and achieving full utilization of advertising resources. An advertising agent employing the web page advertising method purchases advertising spaces from a medium and bills advertisers on a pay-per-click basis.

### CROSS-REFERENCE TO RELATED APPLICATIONS

This application is a continuation-in-part (CIP) of co-pending U.S. Patent Application Ser. No. 11/190,979, filed on Jul. 28, 2005, which relies for priority on Taiwanese Application No. 094136628, filed on Oct. 19, 2005, the contents of which are incorporated herein by reference.

### BACKGROUND OF THE INVENTION

1. Field of the Invention

The invention relates to a webpage advertising method and a method of running an advertising agency using the web page advertising method, more particularly to a web page advertising method having a learning mechanism, to a method of running an advertising agency using the web page advertising method, and to a web page advertising system.

2. Description of the Related Art

With the popularity of computer applications and the vast application of the Internet, searching various database systems on the Internet to browse useful data through various portals, such as Yahoo®, PChome®, or news websites, has become an important activity in one's daily routine. In addition, since computer systems can integrate various useful information into huge databases, and since such huge databases can be linked together to form an even larger database over the Internet, search engines for searching documents on the Internet have been developed. At present, well known large search engines include Google®, Yahoo®, etc. Such search engines generally exist in the form of web sites. When a user enters such a search web site, he/she only needs to enter a so-called keyword on a web page, and the search engine will automatically search all the linked large web sites for articles that match the search parameter, and display arranged partial contents or subjects of the located articles on the web page. Hereinbelow, related terms such as portals, news web sites, and search engines are collectively referred to as network media for the sake of simplicity.

In view of the drastic increase in the population utilizing the network media as well as the rate of utilization, many business opportunities lie behind the displayed web pages. Thus, a cooperative relationship is established between an advertiser and the network media directly or indirectly through an agent or broker, and advertisements of the advertiser are placed on the web pages in the form of banners, pop-up advertisements, rich-media advertisements, etc.

According to the current technology, when the advertiser wants to have an advertisement placed at a portal or on a page dedicated to a specific subject under the portal, the advertiser buys an advertising space from the web site, and pays the web site per view. A typical portal page provides linking and browsing of different subjects, as well as search services, and displays advertisements on the portal page. If an advertiser buys a right to display an advertisement 10000 times in one of the advertising spaces, the advertiser can place the advertisement in the purchased advertising space. When the advertisement is browsed or displayed on the portal 10000 times, the right of the advertiser lapses. Since a portal provides numerous subjects, and since browsers or target customers entering the web site are interested in different subjects, the theme of the advertisement may not be attractive to all browsers alike, so that there is only a very low click rate, may be less than 5 clicks in total.

In the prior art, a web page featuring “cars” may be linked to the portal. The advertising spaces on the web page are mostly favored by advertisers of car manufacturers, car stereo manufacturers, and car accessory manufacturers who hope to achieve a higher click rate.

An alternative web page advertising method is mainly applied to news web sites. A news web site generally categorizes news contents, and the advertisements are placed on the web pages of news of related subjects.

The conventional web page advertising model described above is the so-called “sell impression” approach. This approach ensures the network media of receivable advertising revenues, but the advertising effect is not very good on the average. For the advertiser, there is the risk of unpredictable advertising effect, and the advertiser has to pay considerably high advertising fees in a lump sum to obtain better advertising space and more exposure, which can be afforded in general only by financially powerful manufacturers.

For a search engine, revenues can be brought in by displaying advertisements. The current technology is that the search engine provides a list of several thousands or even tens of thousands of keywords for competitive bidding by advertisers, and the advertisements of the advertisers are listed and displayed in order of bid amounts. The advertisers are charged in units of clicks. Supposing a car loan company and a second-hand car dealer competed for the bid for the keyword “car” and they both won the bid for the keyword “car” by offering NT $5.00 per click and NT $4.00 per click, respectively, when the search engine conducts a search based on the keyword “car” entered by a user, the search engine will search the web sites linked thereto and list the documents matching the keyword. At the same time, the search engine will go to an advertisement database to search for the advertisements of the car loan company and the second-hand car dealer, and will display the two advertisements in order of decreasing bid amounts on the search result page. Only when the user clicks on the advertisement will the search engine provider charge the advertiser for the corresponding advertising fee.

Such a conventional web page advertising model is referred to as “sell click.” Since the advertisements are related to the subject of the search, the advertising effectiveness is comparatively higher than the aforementioned prior art. Besides, such an approach is more affordable for advertisers with limited budgets. However, the “sell click” advertising model still has many problems, as set forth below:

1. Limitation to media types: Since the search parameters entered by users are primarily keywords, and since the object of transaction between the web site and the advertiser is keywords, such a web page advertising model is not suitable for a portal or news web site that is provided merely for browsing purposes, and is applicable only in search engines.

2. Effect of a bidded keyword: Every advertiser wants to buy keywords that are associated with its products and that are readily conceivable by consumers. Therefore, some particular keywords provided by a search engine provider are very popular so that the amounts of bids placed thereon are higher. When the bid amount of a keyword is higher than the average bid amount, the cost of advertising might not be worthwhile for some.

3. Utilization of advertising resources: In contrast to the more popular keywords, less popular keywords, although they are associated with a specific theme or product, are often neglected by advertisers who favor the more popular keywords in their decision-making or who do not consider carefully, so that they become inventory keywords. However, these less popular keywords may be synonyms or related words of the popular keywords. When such less popular keywords are used as search parameters, advertisements seldom appear. Thus, this is a waste of business opportunities.

4. Effectiveness of advertisements: For the car loan company which placed bids on the keyword “Cars,” its car loan advertisement appears only when a user enters the keyword “cars” as a search parameter. However, for a user searching for information about “cars,” he/she may not need a loan, and may be only interested in knowing the performances of certain car models. Therefore, there is vast room for improvement in terms of the effectiveness of the advertisement for such a model of buying keywords and showing the advertisement when the keywords are entered in a search.

In short, a media owner wants to exploit the advertising spaces/resources to the full and reap as many revenues as possible, while an advertiser wants to have its advertisement appear at an opportune time to catch the attention of browsers or users of a search engine. However, for the current methods of web page advertising and running a web page advertising agency, they fail to satisfy the needs of the media owner and the advertiser.

As a result, every portal owner and search engine provider is eager to develop methods for enhancing advertising efficiency. For example, U.S. Pat. No. 6,763,334 discloses a system and method of arranging delivery of advertisements over a network such as the Internet. The aforesaid patent discloses an advertising platform on the Internet to provide automated advertising agency services, which primarily include selecting a media web site according to conditions inputted by an advertiser and the nature of the advertisement, establishing an advertisement contract, placing the advertisement, preparing a statistical report, and calculating a fee in units of the number of responses to the advertisement. However, the aforesaid patent merely shows a statistical result, and does not contribute any improvement to search technology. Neither does it have a learning mechanism. Therefore, the aforesaid patent is still incapable of providing a solution to the dilemma the media owner and the advertiser are in.

### SUMMARY OF THE INVENTION

Therefore, an object of the present invention is to provide a method for web page advertising, which can increase advertisement click rates considerably, and which can fully utilize network media advertising resources.

Another object of the present invention is to provide a web page advertising system which can increase advertisement click rates considerably, and which can fully utilize network media advertisement resources.

Still another object of the present invention is to provide a method of running a web page advertising agency, which can increase advertisement click rates considerably, and which can fully utilize network media advertising resources.

Accordingly, the method for web page advertising of the present invention is adapted to display an advertisement file on a web page of a medium for browsing and/or clicking by a user, and includes:

(A) receiving action information associated with display of a first web page from the medium;

(B) analyzing content of the first web page and expressing the content using a plurality of attribute parameters related to the content of the first web page, and corresponding weighting parameters thereof; the attribute parameters related to the content of the first web page being generated by factoring the content of the first web page according to a term database, the term database containing a plurality of meaningful terms, each of the attribute parameters corresponding to one of the meaningful terms in the term database, the weighting parameters corresponding to the attribute parameters being determined according to one of a frequency of appearance of the respective term in an existing database, and a tag of a language used to create the first web page, under which tag the respective term appears;

(C) determining an advertisement search conditional set, the advertisement search conditional set being determined primarily based on the content of the first web page, and including a plurality of attribute parameters describing the advertisement search conditional set, and corresponding weighting parameters thereof; the attribute parameters of the advertisement search conditional set being selected from the attribute parameters related to the content of the first web page in step (B), the advertisement search conditional set being alternatively determined according to a web page search condition entered by the user, the web page search condition entered by the user being one of a channel, a heading of an article, and a name of a linked web site clicked by the user, a keyword entered by the user, and keywords and a logical symbol entered by the user;

(D) calculating one of a similarity and a difference between the advertisement search conditional set and existing advertisement files, and selecting at least one of the advertisement files, each of the advertisement files including an indexing document, the indexing document including a plurality of attribute parameters describing an advertisement and corresponding weighting parameters thereof, the attribute parameters of the indexing document including contents of an advertised product or service, target customers, and attributes of the advertised product, the attributes of the advertised product being in the form of at least one of keywords, phrases and sentences that describe the advertisement, the similarity being calculated by calculating a similarity value between the advertisement search conditional set and the indexing document of each of the advertisement files, and subsequently comparing the similarity value with a threshold value, at least one of the advertisement files whose indexing document has a similarity value that matches the threshold value being selected as an advertisement search result, which is tantamount to “finding text with text”; and

(E) enabling the at least one advertisement file thus selected to be displayed on the first web page.

The method for web page advertising according to the present invention further includes a step (F) of receiving action information associated with user clicking of the advertisement file thus displayed. When one of the attribute parameters in the content of the first web page is the same as one of the attribute parameters in the indexing document of the advertisement file, and when a product obtained by multiplying the corresponding weighting parameters of the respective attribute parameters that appear in both the content of the first web page and the indexing document is relatively high, at least one of the corresponding weighting parameter of said one of the attribute parameters in the advertisement search conditional set and the corresponding weighting parameter of said one of the attribute parameters in the indexing document is up-adjusted. Alternatively, after step (E), a number of page views of the first web page, a number of clicks received by the advertisement file appearing with the first web page, and a ratio of the number of clicks received by the advertisement file to the number of page views of the first web page are calculated. The ratio is compared with a predetermined value. When the ratio is smaller than the predetermined value, and when a respective one of the attribute parameters in the indexing document of the advertisement file is the same as a respective one of the attribute parameters in the advertisement search conditional set, at least one of the corresponding weighting parameter of the respective one of the attribute parameters in the advertisement search conditional set and the corresponding weighting parameter of the respective one of the attribute parameters in the indexing document is down-adjusted. This is a first learning mechanism of the present invention.

In addition, the present invention further includes a second learning mechanism, which is employed to conduct analysis of contents of the first, second and third web pages browsed in sequence by the user. All the weighting parameters of the first, second and third web pages are multiplied by first, second and third percent age values, respectively. If there is a relatively large difference in content between one of the web pages and the other web pages, the percentage to be multiplied to the weighting parameters of said one of the web pages is lowered.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram of a preferred embodiment of a web page advertising system according to the present invention;

FIG. 2 shows an interface for inputting content of an advertisement file in a preferred embodiment of a method for web page advertising according to the present invention;

FIG. 3 is a flowchart of a basic advertising mechanism in the preferred embodiment of the method for web page advertising according to the present invention;

FIG. 4 is a schematic diagram to illustrate a state after execution of step 55 of FIG. 3;

FIG. 5 is a schematic diagram to illustrate a first learning mechanism in the preferred embodiment of the method for web page advertising according to the present invention; and

FIG. 6 is a schematic diagram of a second learning mechanism in the preferred embodiment of a method for web page advertising according to the present invention.

### DETAILED DESCRIPTION OF THE PREFERRED EMBODIMENT

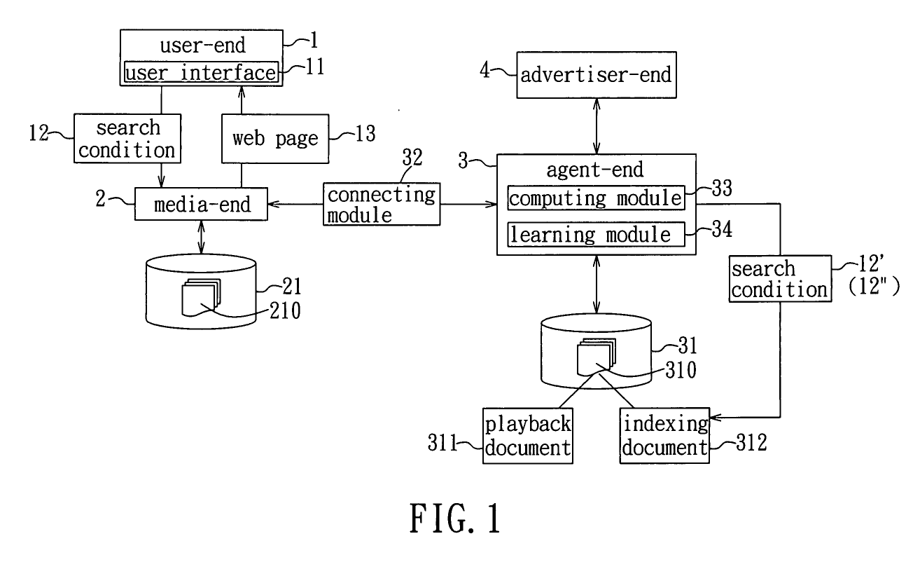

As shown in FIG. 1, the preferred embodiment of a method for web page advertising according to the present invention is adapted to be implemented in a web page advertising system so as to display content of an advertisement on a web page while providing a user with web page browsing and/or searching services. The web page advertising system is constructed among a user-end 1, a media-end 2 representing each portal or search engine, an agent-end 3, and an advertiser-end 4, and includes a user interface 11, a web page database 21, and an advertisement database 31, a connecting module 32, a computing module 33, and a learning module 34 which are primarily administered at the agent-end 3.

The user interface 11 is located at the user-end 1, and is connected to the media-end 2 for displaying a web page 13 provided by the media-end 2 and for allowing a network user,i.e.,a target customer,to interactively enter one or more web page search conditions 12. In a broad sense, the web page search condition 12 referred to herein means an entered keyword, keywords and a logical symbol, and an action of clicking an article or link.

The web page database 21 is collectively constructed from data files stored permanently or temporarily in web sites linked to the media-end 2 and the media-end 2 itself, and stores a plurality of web page files 210.

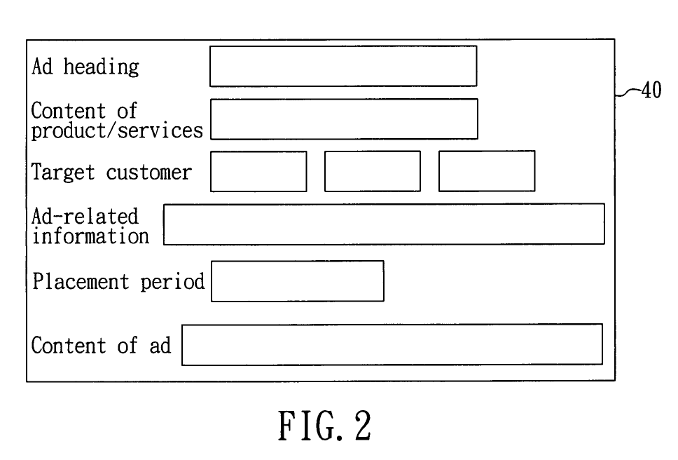

Referring to FIG. 2, the advertisement database 31 stores a plurality of advertisement files 310. Each advertisement file 310 is created from data entered by an advertiser through an advertisement input interface 40. According to the entered data and content subsequently obtained via computation by the learning module 34, each advertisement file 310 can be parsed to include a playback document 311 for showing or playback on a web page, and an indexing document 312 serving as a basis for calculation. Content of the indexing document 312 includes a plurality of attribute parameters to describe attributes of an advertisement, and corresponding weighting parameters, which can be expressed in vectorized terms using the following equation 1.1 or in coordinatized terms using the following equation 1.2:
\vec{A}ᵢ=\vec{I}_{A1}×W_{A1}+\vec{I}_{A2}×W_{A2}+ . . . +\vec{I}_{An}×W_{An} Equation 1.1
A=(I_{A1},W_{A1}),(I_{A2},W_{A2}),(I_{A3},W_{A3}) equation 1.2
where I_{A} represents an attribute parameter which describes the advertisement, and which is basically generated according to data, such as heading of the advertisement, content of product or service, target customer, advertisement-related information, etc., entered by the advertiser through the advertisement input interface 40, and by employing the principle of factoring compound terms. Therefore, in the field for entering the advertisement-related information, keywords, sentences, short passages, etc., can be entered. This is a breakthrough over the prior art which poses a limitation on the number of the keywords. W_{A} represents a weighting parameter that each I_{A} corresponds.

The connecting module 32 is a program installed at the media-end 2 to permit communication of information between the media-end 2 and the agent-end 3 and to permit synchronized actions thereof, for example, enabling the agent-end 3 to know the search conditions received from the user interface 11 at the media-end 2 and the contents of the pages displayed by the media-end 2, or enabling the agent-end 3 to send the advertisement file 310 that was selected by computation to the media-end 2. The computing module 33 and the learning module 34 are primarily located at the agent-end 3. The operation and functions thereof will be detailed in the following description in connection with the steps of the method according to the present invention.

It is noted that the agent-end 3 in this invention can operate in any form. The agent-end 3 may exist in a computer system of an advertisement agent. It may exist in a server at the media-end 2 so as to be integrated therewith. It may even exist in the user's computer in the form of a data storage device (e.g., optical disk, mobile disk, hard disk).

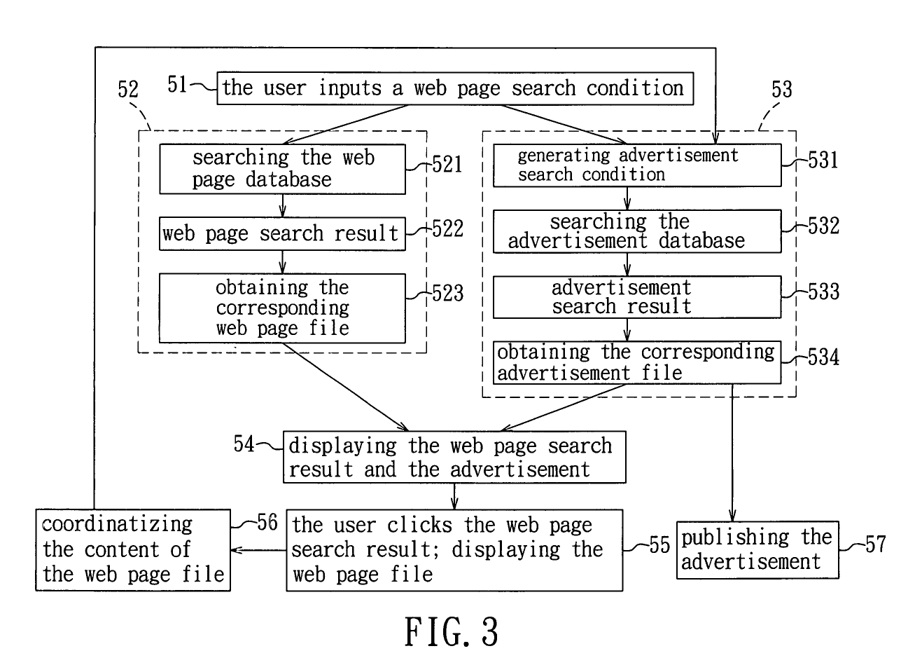

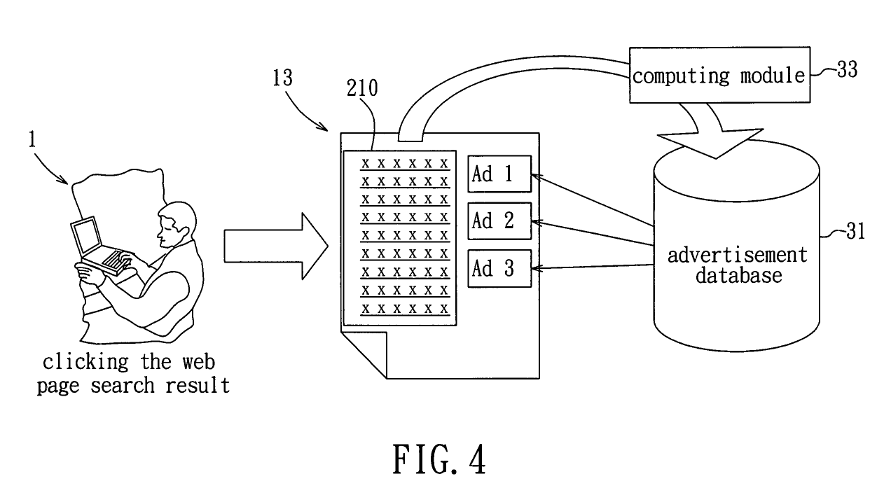

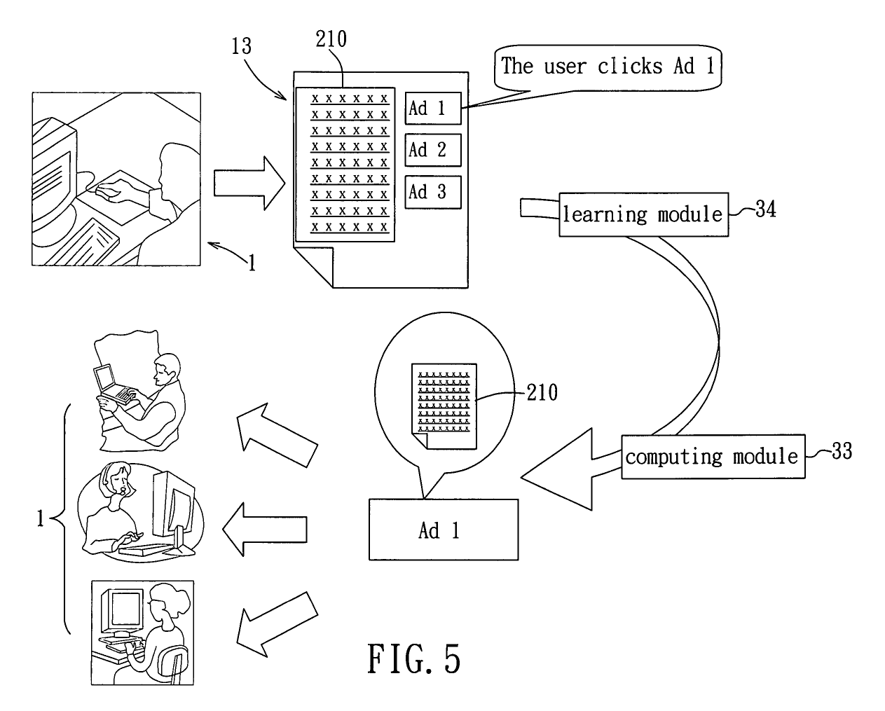

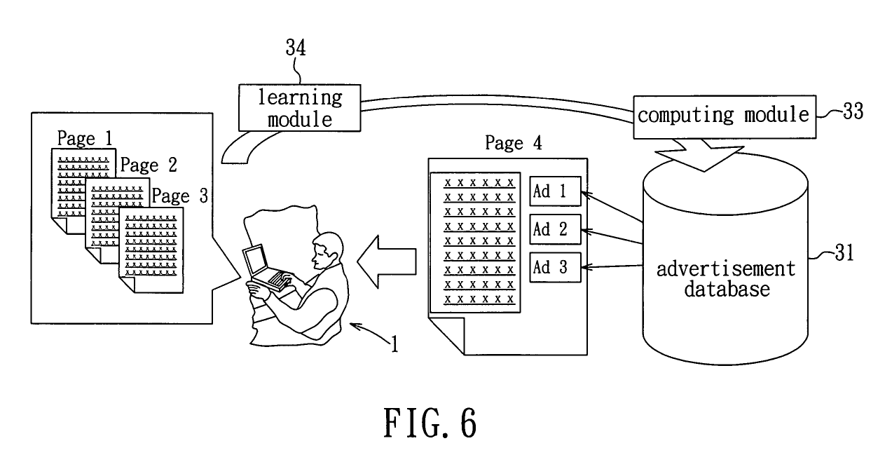

The method for web page advertising of the present invention can be generally divided into a basic advertising mechanism as shown in FIGS. 3 and 4, an additional first learning mechanism as shown in FIG. 5, and an additional second learning mechanism as shown in FIG. 6, as described hereinbelow:

[Basic Advertising Mechanism]

Referring to both FIG. 1 and FIG. 3, the following steps are performed so as to find advertisements with a high correlation by computation according to the content of the web page that is being browsed by the user in order to increase the click rate.

In step 51 (which takes place at the user-end 1), the network user enters a web page search condition 12 through a user interface 11. If the medium that is linked to the user interface 11 is a portal, the web page search condition 12 may be a channel clicked by the user, a subject heading of an article, or a name of a linked web site. If the linked medium is a search engine, the web page search condition 12 may be a keyword, keywords and a logical symbol, etc., entered by the user.

In step 52 (which takes place at the media-end 2), the corresponding network medium receives the web page search condition 12, and the following sub-steps are performed:

In step 521, the medium links to the webpage database 21 and performs a search. As techniques relating to search of the web page database 21 at the media-end 2 are not the crux of the present invention, they will not be discussed herein for the sake of brevity.

In step 522, web page files 210 matching the web page search condition 12 are regarded as web page search results.

In step 523, the web page files 210 to which the web page search results correspond are obtained from the media-end 2 itself or from the linked web sites.

In step 53 (which takes place at the agent-end 3), by means of the connecting module 32, the agent-end 3 activates the computing module 33 to execute the following sub-steps concurrently with the execution of step 52:

In step 531, a first advertisement search conditional set 12′ is generated according to the web page search condition 12. The first advertisement search conditional set 12′ in this invention is transformed to a vector equation (equation 2.1) or a coordinate equation (equation 2.2) composed of a plurality of attribute parameters and corresponding weighting parameters thereof, as follows:
\vec{C}_{J}=\vec{I}_{C1}×W_{C1}+\vec{I}_{C2}×W_{C2}+ . . . +\vec{I}_{Cm}×W_{Cm} equation 2.1
C=(I_{C1},W_{C1}),(I_{C2},W_{C2}),(I_{C3},W_{C3}) equation 2.2
where I_{C} represents the attribute parameter of the first advertisement search conditional set 12′, and may be based on the web page search condition 12 entered by the user; and W_{C} represents a weighting parameter corresponding to each I_{C}.

In step 532, the agent-end 3 is connected to the advertisement database 31, and compares the indexing document 312 of each advertisement file 310 with the first advertisement search conditional set 12′ so as to calculate a similarity or difference. A similarity value can be calculated using the following equation 3:

$$S = {\sum }_{1}^{n , m} {W}_{Ai} \times {W}_{Cj} , ∀ {I}_{Ai} = {I}_{Cj} \qquad equation 3$$

In step 533, the similarity or difference is compared with a threshold value, and at least one indexing document 312 that matches the threshold value is selected to serve as the advertisement search result.

In step 534, the advertisement file 310 corresponding to the advertisement search result is retrieved from the advertisement database 31, and is sent to the media-end 2.

In step 54, the search result and the advertisement file 310 respectively obtained in steps 523 and 534 are displayed on the web page 13 in the form of subject headings or extracted passages through the media-end 2.

Through the aforesaid steps, since the advertisement file 310 as displayed is correlated to the search condition 12 entered by the user at the start, and to the currently displayed web page 13, the user may click the advertisement link so that the agent-end 3 will enter into the first learning mechanism, or step 55 is performed.

In step 55, the user clicks the web page search result, and the user interface 11 is linked to the media-end 2 to display the corresponding web page file 210. Referring to both FIG. 3 and FIG. 4, when step 55 is being conducted, the agent-end 3 can likewise obtain the content of the web page file 210 through the connecting module 32, and can enable the computing module 33 to execute step 56.

In step 56, the content of the web page file 210 thus located in the search is vectorized or coordinatized. In other words, the content is decomposed into a parameter combination of multiple dimensions and corresponding weightings. Each dimension corresponds to an attribute (e.g., a keyword) contained in the content of the web page. The coordinates of the web page file 210 can be expressed using the following equation 4.
P=(I_{P1},W_{P1}),(I_{P2},W_{P2}),(I_{P3},W_{P3}) equation 4

Supposing the content of the web page is an article, terms in the article are factored according to a term database. Each term factoring result is assigned a corresponding weighting. The term database contains a multiplicity of meaningful terms for use in factoring of compound terms. For example, the compound term “golf course” can be factored into meaningful terms of “golf (the game),” “golf (the ball),” “course,” and “golf course.” As for the determination of the corresponding weightings, it is based at least on the following items:

a. Term frequency: This is a measure of how often a term appears in a document. A higher frequency indicates that the term has greater importance in the content of the document, and accordingly has more weight.

b. Document frequency: This is a measure of how often a term appears in the entire database. Since insignificant words like prepositional and conjunctive words or phrases appear most frequently in the entire database, a term having a low document frequency is accorded greater importance.

c. Tags in HTML: A web page created in HTML can be divided into parts, including <head> and <body>, according to the tags. The terms appearing under the head tag generally has a greater weighting than those appearing under the body tag.

After step 56, sub-steps 531-534 are repeated once again. Lastly, step 57 is executed.

Instep 57, the advertisement search result obtained in step 534 is published in the web page displayed in step 55 through the media-end 2.

The sub-steps 531-534 that are executed after step 56 are different from the sub-steps 531-534 when they were executed for the first time. In step 531 after step 56, a vectorized second advertisement search conditional set 12″ is generated according to the content of the web page file 210 thus located for similarity comparison with the indexing document 312 of the advertisement file 310, which is also a vector equation. This is like “finding text with text,” and overcomes the bottleneck encountered by the prior art keyword search techniques in terms of input and effect.

In other words, in step 531 of the method for web page advertising according to the present invention, the advertisement search conditional set 12′ can be generated according to the web page search condition 12 entered by the user. Alternatively, the advertisement search conditional set 12″ can be generated according to the content of the web page 13 that the user is browsing. Since the second advertisement search conditional set 12″ is generated according to the content of the web page being browsed by the user, the most relevant advertisements to the web page can be delivered in real time and shown together with the web page dynamically, thereby increasing the click rate of the advertisements.

It is noted that the present invention applies the above-described techniques to vectorize the advertisement search conditional sets, vectorize or coordinatize web page contents, factor compound terms, set weightings, etc., so that the generation of the first or second advertisement search conditional set 12′, 12″ is no longer restricted to the web page search condition 12 entered by the user. On the other hand, “concept-based” search conditions are generated by “finding text with text.” To illustrate, when the user enters a keyword “whitening” as a search condition 12, since other terms, such as “dark pigments” and “spot lightening,” which have a meaning associated with the keyword are analyzed from the content of the relevant web page 13 that subsequently appears, it is possible that parameters such as “dark pigments” and “spot lightening” can be automatically and conceptually extended from the keyword when the advertisement search conditional set 12″ is determined, thereby encompassing all the information that the user may want to obtain. In addition, for the advertisement file 310, since the advertisement attribute parameters included in the indexing document 312 contain information related to the advertisement, and since such related information includes a large number of keywords and attributives provided by the advertiser 4, such as the words or phrases “whitening,” “lighten dark pigments,” “reduce precipitation of dark pigments,” “lighten spots,” etc., related to skin whitening products and entered in the field of advertisement-related information by the advertiser, compared with the prior art which allows the advertiser to buy keywords, the present invention can better describe the advertisement and increase the advertisement match rate. Hence, media advertising resources will not be wasted, and suitable advertisements can be arranged to fill advertising spaces provided by the medium.

[First Learning Mechanism]

Referring to FIG. 5, when the user clicks an advertisement on the displayed web page 13 this indicates that the clicked advertisement that was delivered after computation at the agent-end 3 is very relevant to the information on the page browsed by the user, and can interest the user in clicking the advertisement. The advertisement clicking action is fed back to the learning module 34 and the advertisement file 310 through the connecting module 32 in real time. According to a common attribute parameter that appears in each of the web page 13 and the advertisement file 310, the corresponding weightings of the common attribute parameter in the advertisement search conditional sets 12′, 12″ and/or the indexing document 312 can be up-adjusted. The common attribute parameter refers to an attribute parameter that appears in both the web page file 210 and the indexing document 312, and that has a relatively high product after the corresponding weightings thereof are multiplied.

On the contrary, in the case that an advertisement was found to be relevant to a certain article through calculation using the basic advertising mechanism but did not receive any click after the article has received, e.g., 1000 page views, the corresponding weightings of the advertisement search conditional sets 12′, 12″ and the relevant attribute parameters in the indexing document 312 of the advertisement file 310 are down-adjusted.

To be specific, a number of page views of the web page 13 containing the article of interest and a number of clicks received by the advertisement file 310 appearing with the web page 13 are first calculated. Then, a ratio of the number of clicks received by the advertisement file 310 to the number of page views of the web page 13 is calculated. The ratio is compared with a predetermined value. When the ratio is smaller than the predetermined value, according to a common attribute parameter that appears in each of the indexing document 312 of the advertisement file 310 and the advertisement search conditional sets 12′, 12″, the corresponding weighting parameters of the common attribute parameter in the advertisement search conditional sets 12′, 12″ and/or the corresponding weighting parameter of the common attribute parameter in the indexing document 312 of the advertisement file 310 can be down-adjusted.

[Second Learning Mechanism]

Referring to FIG. 6, the second learning mechanism is performed through a user's browsing path. For instance, it is assumed that the user browsed linked web pages 1, 2 and 3 directly or indirectly in sequence. The contents of the previously browsed pages 1, 2 and 3 will become training data of advertisements, and have an effect on the advertisements that are displayed on a currently browsed web page 4. The training data are fed back to the learning module 34 in real time through the connecting module 32 for real-time analysis of the objects of interest to the user. The computing module 33 learns and adjusts the weighting parameters of the search conditional set 12″, and delivers the advertisements that are correlated to the articles on the web page to the web site in real time. Relevant advertisements are thus generated dynamically in the web page currently browsed by the user.

There are primarily two approaches of implementing the aforesaid method in actual practice in one approach, the correlation of the contents of the previously browsed web pages 1, 2 and 3 to the currently browsed web page 4 is generally determined to be web page 3 >web page 2 >web page 1. Therefore, the percentages of the effects of the contents of the web pages 1, 2 and 3 on the advertisement search conditional set 12″ that has yet to be generated can be set to be 15%, 35% and 50%. In the other approach, in case the correlation between the web page 2 and the other web pages is very low, the ratio of the web page 2 is down-adjusted so that the percentages of the web pages 1, 2 and 3 are 30%, 5%, and 65%.

Therefore, in step 55, every time the user clicks on an advertisement or clicks a search result to display the corresponding web page file 210, the clicking actions of the user are accumulated and constantly affect the weighting parameters of the advertisement search conditional set 12″. When other users browse similar or related products or web pages, advertisements that have an empirically high correlation can be calculated with greater precision to ensure a higher click rate of the advertisements, thereby enabling the advertiser to develop potential consumer markets.

The present invention further proposes a method of running a web page advertising agency, which is adapted to have a plurality of advertisement files 310 of at least one advertiser displayed on a web page 13 of a media-end 2 for browsing and/or clicking by a user. The method includes the following steps:

(a) obtaining an advertising space on a web page of the medium-end 2;

(b) obtaining the advertisement files 310;

(c) constructing an advertisement database 31 containing the advertisement files 310, each of the advertisement files 310 including a playback document 311 to be played back on the media-end 2, and an indexing document 312 describing an attribute of the respective advertisement file 310;

(d) receiving action information associated with display of a first web page 13 from the medium-end 2;

(e) analyzing content of the first web page 13, and expressing the content of the first web page 13 using a plurality of attribute parameters related to the content of the first web page 13, and corresponding weighting parameters thereof;

(f) determining an advertisement search conditional set 12′, the advertisement search conditional set 12′ being determined primarily according to the content of the first web page 12 and including a plurality of attribute parameters describing the advertisement search conditional set 12′, and corresponding weighting parameters;

(g) in the advertisement database 31, calculating one of a similarity and a difference between the advertisement search conditional set 12′ and the indexing documents 312 of the advertisement files 310, and selecting at least one of the advertisement files 310 therefrom;

(h) enabling said at least one advertisement file 310 thus selected to be displayed on the first web page 13; and

(i) receiving and calculating the number of times the advertisement file 310 was clicked to display the corresponding playback document 311, and billing the advertiser based on the calculated number of times the advertisement was clicked.

Preferably, in step (a), the advertising spaces were obtained by purchasing the advertising spaces from the media-end 2 on a pay-per-display basis.

As illustrated, the advertising mechanism and the learning mechanisms that are constructed on the basis of the particular computation model of the present invention provide a breakthrough in current portal search or engine technologies, and can increase click rates of advertisements considerably. In this case, according to the method of running an agency for web page advertisements, the advertiser can be charged on a pay-per-click basis and a standard fee which is comparatively lower than the current industry average bid charge for a keyword per click. In other words, the advertiser will be charged only when its advertisement is clicked. For the advertiser, clicks can be bought at a relatively low cost, and are worth every penny. On the other hand, for the media owner, more revenues can be reaped. Besides, advertising space resources can be fully exploited. As for the advertising agency, since a higher click rate is ensured, considerable profits can be ensured as well.

As illustrated, the method of running an advertising agency according to the present invention combines the advantages of conventional “sell impressions” and “sell clicks” advertising models, and can eliminate drawbacks associated with the conventional “sell impressions” model in which advertisers are charged relatively high advertising fees and have to run the risk of ineffectiveness of the advertisements. The present invention can also overcome drawbacks associated with the conventional “sell clicks” model, which can be adopted by limited types of media, which is constrained by the keyword search effect, and which entails ill effects on keyword bidding market. The present invention can be employed to create a network advertising market that can benefit the media, the advertiser, and the advertising agency.

In sum, the method and system for webpage advertising of this invention can completely overcome the technical constraints associated with current keyword searching technology by utilizing a “finding text with text” technique, i.e., the coordinatization and vectorization of web page contents and advertisement files through setting of attribute parameters and of adjusting weighting parameters. Besides, the present invention provides a learning mechanism based on the clicking and browsing actions of the user to permit effective matching between contents of the advertisements and the displayed web page, thereby increasing the advertisement click rate considerably while ensuring adequate utilization of network media advertising resources. Furthermore, the media and the advertiser can benefit from the method of running a web page advertising agency of the present invention. Thus, the objects of the present invention can be achieved.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A method for web page advertising, which is adapted to display an advertisement on a web page of a medium for browsing and/or clicking by a user, said method comprising:
(A) receiving action information associated with display of a first web page from the medium;
(B) analyzing content of the first web page and expressing the content using a plurality of attribute parameters related to the content of the first web page, and corresponding weighting parameters thereof;
(C) determining an advertisement search conditional set, the advertisement search conditional set being determined primarily based on the content of the first web page, and including a plurality of attribute parameters describing the advertisement search conditional set and corresponding weighting parameters thereof;
(D) calculating one of a similarity and a difference between the advertisement search conditional set and existing advertisement files, and selecting at least one of the advertisement files, each of the advertisement files including an indexing document, the indexing document including a plurality of attribute parameters describing an advertisement and corresponding weighting parameters thereof; and
(E) enabling the at least one advertisement file thus selected to be displayed on the first web page.

2. The method for web page advertising according to claim 1, wherein the attribute parameters of the advertisement search conditional set in step (C) are selected from the attribute parameters related to the content of the first web page in step (B).

3. The method for web page advertising according to claim 1, wherein the attribute parameters related to the content of the first web page are generated by factoring the content of the first web page according to a term database, the term database containing a plurality of meaningful terms, each of the attribute parameters related to the content of the first web page corresponding to one of the meaningful terms in the term database.

4. The method for web page advertising according to claim 3, wherein the corresponding weighting parameter of each of the attribute parameters in step (B) is determined according to a frequency of appearance of a term corresponding to the respective attribute parameter in an existing database.

5. The method for web page advertising according to claim 3, wherein the corresponding weighting parameter of each of the attribute parameters in step (B) is determined according to a tag of a language used to create the first web page, under which tag a term corresponding to the respective attribute parameter appears.

6. The method for web page advertising according to claim 1, wherein the attribute parameters of the indexing document in step (D) include contents of an advertised product or service, target customers, and attributes of the advertised product.

7. The method for web page advertising according to claim 6, wherein each of the attribute parameters of the indexing document includes one of a keyword, a phrase, a sentence, and a short passage which describe the advertisement.

8. The method for web page advertising according to claim 1, wherein, in step (D), a similarity value between the advertisement search conditional set and the indexing document of each of the advertisement files is calculated, and the similarity value is compared with a threshold value, at least one of the advertisement files whose indexing document has a similarity value that matches the threshold value being selected as an advertisement search result.

9. The method for web page advertising according to claim 1, further comprising a step (C′) of determining another advertisement search conditional set according to a web page search condition entered by the user.

10. The method for web page advertising according to claim 9, wherein the web page search condition entered by the user in step (C′) is one of a channel, a heading of an article, and a name of a linked web site clicked by the user, a keyword entered by the user, and keywords and a logical symbol entered by the user.

11. The method for web page advertising according to claim 1, further comprising a step (F) of receiving action information associated with user clicking of the advertisement file thus selected after step (E), and returning to step (C), in which when one of the attribute parameters in the content of the first web page is the same as one of the attribute parameters in the indexing document of the advertisement file, and when a product obtained by multiplying the corresponding weighting parameters of the respective attribute parameters that appear in both the content of the first web page and the indexing document is relatively high, the corresponding weighting parameter of said one of the attribute parameters in the advertisement search conditional set is up-adjusted before proceeding with steps (D) and (E).

12. The method for web page advertising according to claim 1, further comprising a step (F) of receiving action information associated with user clicking of the advertisement file thus selected after step (E), and returning to step (D), in which when a respective one of the attribute parameters in the content of the first web page is the same as a respective one of the attribute parameters in the indexing document of the advertisement file, and when a product obtained by multiplying the corresponding weighting parameters of the respective attribute parameters that appear in both the content of the first web page and the indexing document is relatively high, the corresponding weighting parameter of said one of the attribute parameters in the indexing document is up-adjusted before proceeding with step (E).

13. The method for web page advertising according to claim 1, further comprising, after step (E):
(G1) calculating a number of page views of the first webpage, a number of clicks received by the advertisement file appearing with the first web page, and a ratio of the number of clicks received by the advertisement file to the number of page views of the first web page;
(G2) comparing the ratio with a predetermined value; and
(G3) returning to step (D) when the ratio is smaller than the predetermined value, in which when a respective one of the attribute parameters in the indexing document of the advertisement file is the same as a respective one of the attribute parameters in the advertisement search conditional set, at least one of the corresponding weighting parameter of the respective one of the attribute parameters in the advertisement search conditional set and the corresponding weighting parameter of the respective one of the attribute parameters in the indexing document is down-adjusted before proceeding to step (E).

14. The method for web page advertising according to claim 1, further comprising, after step (A):
(A′) receiving action information associated with display of a second web page from the medium;
(B′) analyzing content of the second web page and expressing the content of the second web page using a plurality of attribute parameters related to the content of the second web page, and corresponding weighting parameters thereof; and
(H) multiplying all the weighting parameters of the first web page by a first percentage value and multiplying all the weighting parameters of the second web page by a second percentage value, the first percentage value being smaller than the second percentage value.

15. The method for web page advertising according to claim 14, further comprising, after step (A′):
(A″) receiving action information associated with display of a third web page from the medium; and
(B″) analyzing content of the third web page and expressing the content of the third web page using a plurality of attribute parameters related to the content of the third web page, and corresponding weighting parameters thereof;
wherein, in step (H), all the weighting parameters of the third web page are multiplied by a third percentage value that is greater than the first and second percentage values;
said method further comprising, after step (H):
(H′) analyzing a similarity among the first, second and third web pages; and
(H″) selecting one of the first, second and third web pages which has a lowest similarity, and reducing the corresponding percentage value of said one of the first, second and third web pages thus selected.

16. A method of running a web page advertising agency, which is adapted to have a plurality of advertisement files of at least one advertiser displayed on a web page of a medium for browsing and/or clicking by a user, said method comprising:
(a) obtaining at least one advertising space on a web page of the medium;
(b) obtaining the advertisement files;
(c) constructing an advertisement database containing the advertisement files, each of the advertisement files including a playback document to be played back on the medium, and an indexing document describing an attribute of the respective advertisement file;
(d) receiving action information associated with display of a first web page from the medium;
(e) analyzing content of the first web page, and expressing the content of the first web page using a plurality of attribute parameters related to the content of the first web page, and corresponding weighting parameters thereof;
(f) determining an advertisement search conditional set, the advertisement search conditional set being determined primarily according to the content of the first web page and including a plurality of attribute parameters describing the advertisement search conditional set, and corresponding weighting parameters;
(g) in the advertisement database, calculating one of a similarity and a difference between the advertisement search conditional set and the indexing documents of the advertisement files, and selecting at least one of the advertisement files therefrom;
(h) enabling said at least one advertisement file thus selected to be displayed on the first web page; and
(i) receiving and calculating the number of times the advertisement file was clicked to display the corresponding playback document, and billing the advertiser based on the calculated number of times the advertisement was clicked.

17. The method according to claim 16, wherein, in step
(a), the advertising spaces were obtained by purchasing the advertising spaces from the medium on a pay-per-display basis.

18. A system for web page advertising, which is adapted to display advertisements on a web page while providing web page browsing and/or searching services, said system being constructed among a network user-end, a media-end, an agent-end, and at least one advertiser-end, and comprising:
a user interface located at the user-end and connected to the media-end to display web pages provided by the media-end and to allow the user-end to interactively enter at least one search conditional set;
a web page database for storing a plurality of web page files; and
an advertisement database, a connecting module, and a computing module administered primarily at the agent-end, said advertisement database storing a plurality of advertisement files, each of the advertisement files including a playback document for playback at the media-end, and an indexing document describing attributes of the respective advertisement file, said connecting module permitting communication of information between the media-end and the agent-end and synchronized actions thereof, said computing module generating an advertisement search conditional set, which is determined mainly in accordance with content of the web page browsed at the user-end and which includes a plurality of attribute parameters describing the advertisement search conditional set, and corresponding weighting parameters thereof.

19. The system for web page advertising according to claim 18, further comprising a learning module which, according to action information associated with clicking of an advertisement file at the user-end, adjusts the weighting parameters of at least one of the advertisement search conditional set and the indexing document of the corresponding advertisement file.

20. The system for web page advertising according to claim 18, further comprising a learning module which, in accordance with action information associated with browsing of a web page at the user-end, adjusts the weighting parameters of the corresponding web page file.

21. The system for web page advertising according to claim 18, wherein the agent-end exists in a computer system of an advertisement agent.

22. The system for web page advertising according to claim 18, wherein the agent-end exists in a server at the media-end so as to be integrated therewith.

23. The system for web page advertising according to claim 18, wherein the agent-end exists in a computer in the form of a data storage device that is one of an optical disk, a mobile disk, and a hard disk.
